(19) United States
(12) Patent Application Publication
(10) Pub. No.: US 2007/0055723 A1
(43) Pub. Date: Mar. 8, 2007

(54) Method and system for performing quad precision floating-point operations in microprocessors

(76) Inventor: Marius Cornea-Hasegan, Portland, OR (US)

Correspondence Address: COURTNEY STANFORD & GREGORY LLP;C/O INTELLEVATE, P.O. BOX 52050, MINNEAPOLIS, MN, 55402, US

(21) Appl. No.: 11/220,797

(22) Filed: Sep. 7, 2005

(51) Int. Cl. G06F 7/38

(52) U.S. Cl. 708/507

(57) ABSTRACT

Embodiments of a method and system for performing quad precision floating-point operations in a microprocessor are disclosed. In one embodiment, a method for calculating the square root of a number in a proposed revised IEEE 754 compliant 64-bit microprocessor comprises performing a single Newton-Raphson iteration in high precision to obtain an underestimate of the result, calculating and rounding the result using a simplified rounding method, and determining whether the result is inexact. In one embodiment, one or more operations of the method are performed using atomic microinstructions for execution in the microprocessor. The instructions store and manipulate the 128-bit quad precision operand using at least two floating-point registers, thus reducing latency in comparison to floating-point square root calculations that use the native instruction set of the microprocessor. Other embodiments are described and claimed.

### FIELD

Embodiments of the invention relate generally to performing quad precision floating point operations in a microprocessor, including instructions for performing quad precision, floating-point calculations.

### BACKGROUND

Due to the limits of finite precision approximation inherent in microprocessors when attempting to model arithmetic with real numbers, every floating-point operation executed by a microprocessor potentially results in a rounding error. To maintain an acceptable minimum level of accuracy, floating-point computations in microprocessors require a relatively complex set of microinstructions. The floating-point square root operation in many current microprocessors is a notable example of a computationally intensive and potentially error-prone operation.

To ensure a common representation of real numbers on computers, the IEEE-754 Standard for Binary Floating-Point Arithmetic (IEEE 754-1985) was established to govern binary floating-point arithmetic. The current version of the standard has been under revision since 2000 (due for completion in December 2005), and is referred to herein as “the proposed revised IEEE 754 standard” or “IEEE 754r.” This standard specifies number formats, basic operations, conversions, and exception conditions, and requires that the result of a divide or square root operation be calculated as if in infinite precision, and then rounded to one of the two nearest floating-point numbers of the specified precision that surround the result.

Due to various factors, such as rounding errors, decimal-binary conversion, improper management of extended precision registers, and so on, the square root (“sqrt”) operation is particularly susceptible to error, and different microprocessors that do not adhere to the proposed revised IEEE 754 standard can generate different results for the same square root operation. Increasing the number of digits of precision used by the microprocessor for the operation can help to ensure the accuracy of the operation. However, such an increase in precision can require substantial processor overhead and increase processing latencies. For example, it has been demonstrated that the correct value for a floating-point square root operation has been calculated in a microprocessor using 200 digits of precision, but the cost of such precision was significant computing time.

Many microprocessors do not have native instructions for quad precision arithmetic operations, such as a quad precision square root operation, or hardware-based implementations for the square root operation. For these microprocessors, execution of the square root function typically involves utilizing a software-based iterative approximation method, such as the Newton-Raphson method, power series expansion, or similar method. Such microprocessors execute iterative operations to perform the square root calculation that can involve hundreds of clock cycles in the critical path of the processor

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a processing system that performs quad precision floating-point operations, according to an embodiment;

FIG. 2 is a flowchart illustrating a quad precision floating-point square root operation, according to an embodiment;

FIG. 3 is a table that lists computations and compares processor clock cycles for the calculation of a floating-point square root value, according to an embodiment;

FIG. 4A is a table that lists a first group of microprocessor instructions for calculating a floating-point square root value, according to an embodiment;

FIG. 4B is a table that lists a second group of microprocessor instructions for calculating a floating-point square root value, according to an embodiment; and

FIG. 5 is a block diagram of a microprocessor that includes a known set of instructions and a reduced-latency set of instructions for executing a quad precision floating-point operation, according to an embodiment.

### DETAILED DESCRIPTION

Embodiments of a method and system for performing quad precision floating-point operations on quad precision operands in a 64-bit microprocessor are described. These embodiments are also referred to herein collectively as the “floating-point operations.” The floating-point operations include square root operations, but are not so limited. Embodiments include a reduced-latency method that can be implemented in microcode operations, software routines or modules (for example, as implemented in a compiler or software libraries supported by a compiler), microprocessor instructions, or hardware implemented logic in the 64-bit microprocessor. Embodiments of the method include executing a Newton Raphson iterative process on a quad precision operand using operations embodied in one or more microprocessor instructions described below. The iterative method comprises the process of calculating a 64-bit approximation of the reciprocal of the square root of the operand, calculating and rounding the result to one of two nearest quad precision floating-point numbers, and determining whether the result is exact or inexact.

The instructions of an embodiment store and operate on the quad precision (128-bit) operand in the floating-point registers of the processor. The instructions of an embodiment are referred to herein as “reduced-latency instructions,” but are not so limited. The reduced-latency instructions of an embodiment include a first set of microprocessor instructions that store the quad precision operand in two floating-point registers. The reduced-latency instructions of an embodiment also include a second set of microprocessor instructions that operate on the two floating-point registers to perform arithmetic and logic operations. By utilizing this storage and logic mechanism, the reduced-latency instructions of an embodiment use fewer clock cycles to perform the arithmetic and logic operations as compared to known methods for performing floating-point square root calculations.

The floating point operations of an embodiment improve the latency of quad square root operations significantly. The floating point operations can also reduce the latency of other quad precision floating-point operations, for example quad precision division. The floating point operations described below also provide good instruction-level parallelism, which makes these operations suited for processors with pipelined functional units, multiple functional units, and/or multiple cores.

Existing known implementations of the quad precision square root operation based on the Newton-Raphson method generate an approximate result that could equally be an underestimate or an overestimate of the precise result. In contrast, the floating point operations and corresponding reduced-latency instructions described herein perform a single Newton-Raphson iteration in high precision to obtain an underestimate of the result, apply a simplified rounding method, efficiently determine whether the result is inexact, and apply reduced-latency instructions that produce reduced latency not only for the quad precision square root, but also for other quad precision floating-point operations.

In the following description, numerous specific details are introduced to provide a thorough understanding of, and enabling description for, embodiments of the floating-point square root calculation methodology and instruction set. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

Embodiments of the floating point operations are directed to the calculation of the quad precision (128-bit) floating-point square root value of a quad precision floating-point argument (or operand). As defined by the proposed revised IEEE 754 standard for binary floating-point arithmetic, the quad precision floating-point format comprises a 1-bit sign plus a 15-bit exponent plus a 113-bit significand which includes an implicit integer bit.

In one embodiment of the floating point operations, a methodology for calculating the square root of a number in a proposed revised IEEE 754 standard compliant quad precision microprocessor comprises:

(1) performing a single Newton-Raphson iteration in high precision to obtain an underestimate of the result,

(2) calculating and rounding the result to quad precision using a simplified rounding method,

(3) checking whether the result is inexact, and

(4) embodying one or more portions of the methodology in one or more atomic microinstructions (e.g., reduced-latency instructions), for execution in a 64-bit microprocessor.

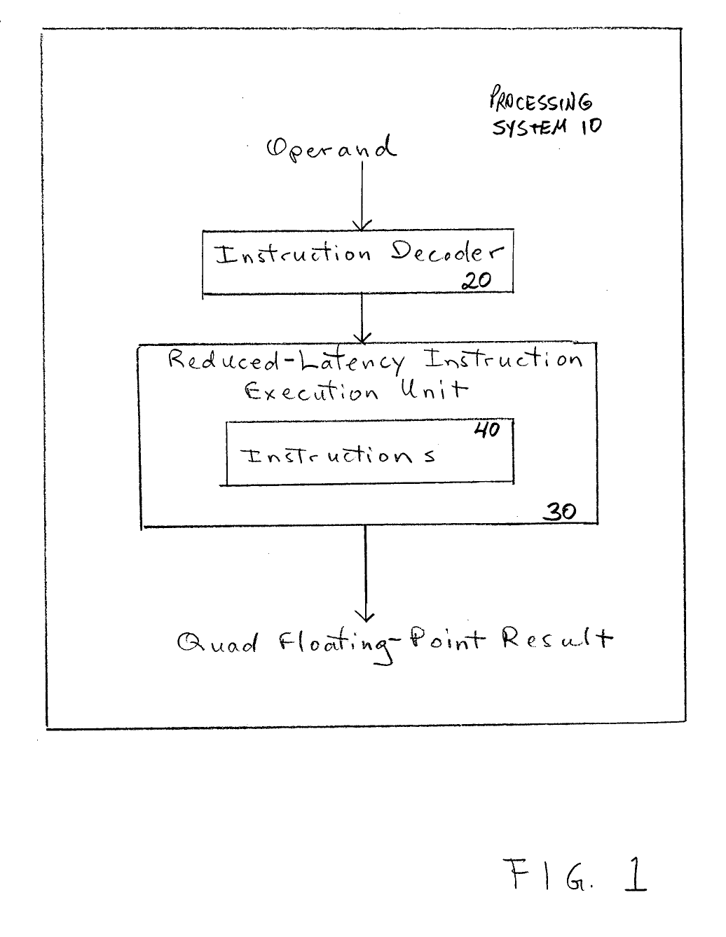

FIG. 1 is a block diagram of a processing system 10 that performs quad precision floating-point operations, under an embodiment. The system 10 includes an instruction decoder 20 that receives instructions for a quad precision floating-point operation. The system further includes a reduced-latency instruction execution unit 30 that is coupled to the instruction decoder 20. The reduced-latency instruction execution unit 30 of an embodiment includes a number of instructions 40 that perform at least one floating-point operation on a quad precision operand received at the system 10. The floating-point operation includes calculating an approximation of a reciprocal of a square root of the quad precision operand using iteration. The approximation of an embodiment is an underestimate. The floating-point operation further includes rounding the approximation to one of two nearest quad precision floating-point numbers. The reduced-latency instruction unit 30 outputs a floating-point square root of the quad precision operand.

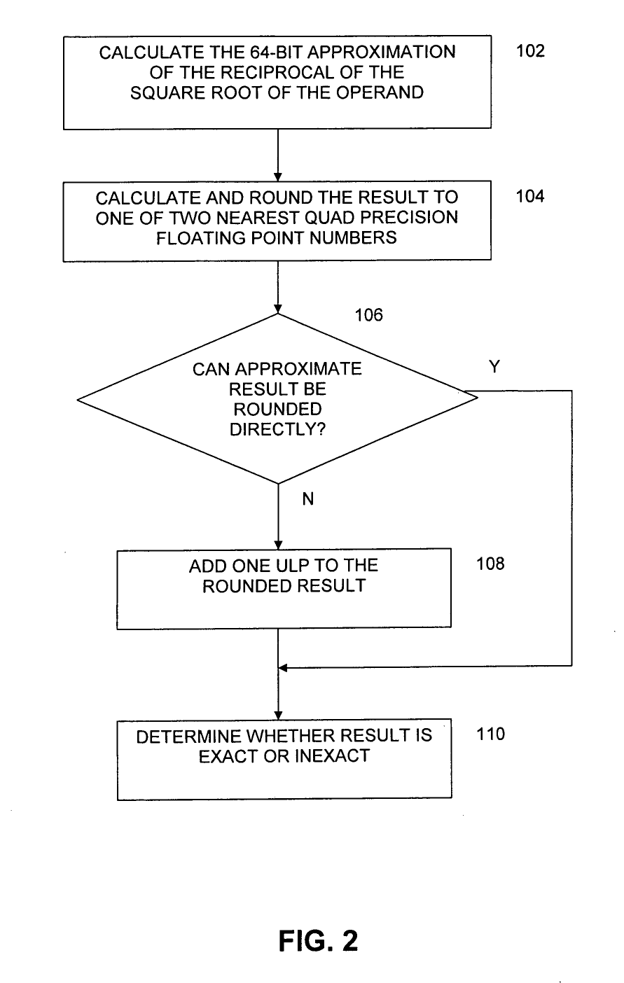

FIG. 2 is a flowchart illustrating a method of performing a quad precision floating-point square root operation in a microprocessor, according to one embodiment. For the embodiment illustrated in FIG. 2, it is assumed that the square root calculation is executed in a microprocessor that supports 64-bit arithmetic. If the microprocessor further supports 64-bit floating-point arithmetic, such as the Intel® Itanium® Processor Family (IPF) architecture, additional efficiency gains in terms of processing speed can be realized. In one embodiment, the method of FIG. 2 is performed by software, for example software provided in a compiler library to support quad precision operations. In another embodiment, the method of FIG. 2 is performed by one or more microprocessor instructions.

The computation begins with the calculation of a 64-bit approximation of the reciprocal of the square root result, 102. This is an underestimate of the exact reciprocal and is used to calculate an underestimate of the result, within a small fraction of a ulp (unit in the last place) from the precise square root value. In 104, the result is calculated and then rounded to one of the two nearest numbers for quad precision. In most cases, the approximate result can be rounded directly and the IEEE 754r-correct quad result is obtained. In general, only a few exceptional cases exist for every rounding mode, and in such cases one ulp may need to be added to the rounded value of the approximate result. Thus, the process determines whether the approximate result can be rounded directly, 106. If not, one ulp is added to the rounded result, 108. After completion of any ulp addition, or a determination that direct rounding is possible, the result is checked to determine whether it is exact or inexact, 110.

The process of FIG. 2 is described in greater detail below for the calculation of the IEEE 754r-correct quad precision floating-point value √a (fsqrt a). It is assumed that the operand a is a positive and normalized quad precision floating-point number. For the process described below, denormalized numbers are first normalized.
1. Truncate the significand of the quad precision input value a (by rounding toward zero) from 113 bits to 64 bits—high part of a, and calculate also the low part of a
   aₕ=(a)_{RZ,64}
   a₁=a−aₕ
2. Calculate a 64-bit underestimate y of 1/√a, within four ulps of 1/√a or better
   y=1/√a·(1−e)
3. Calculate s using round-to-nearest to 64 bits, and h
   s=(aₕ·y)_{RN,64}
   h=½·y//exact
4. Calculate
   (s²)ₕ=(s·s)_{RN,64}
   (s²)₁=s·s−(s²)ₕ//exact
   dₕ=aₕ−(s²)ₕ//exact
   d₁=(a₁−(s²)₁)_{RN,64}
   d=(dₕ+d₁)_{RN,64}
5. Calculate
   p=(d·h)_{RN,64}
6. Calculate exactly r*=s+p with 128 significant bits
   rₕ*=(s+p)_{RZ,64}//use truncation (rounding to zero)
   t=s−rₕ*//exact
   r₁=t+p//exact
   Scale r₁* so that its exponent is that of rₕ* minus 64 (lower bits may be discarded).
7. Let r′=(r*)_{Rz,113}
   For RN (round to nearest):
      If r*₁₁₃r*₁₁₄ . . . r*₁₁₈=011111 and r′+½ ulp<√a or r*₁₁₂r*₁₁₃ . . . r*₁₂₇=0100 . . . 0, then r=r′+1 ulp
         Else r=(r*)_{RN,113}
   For RM, RZ (round down, round to zero):
      If r*₁₁₃r*₁₁₄ . . . r*₁₁₈=111111 and r′+1 ulp<=√a, then r=r′+1 ulp
         Else r=r′
   For RP (round up):
      If r*₁₁₃r*₁₁₄ . . . r*₁₁₈=111111 and r′+1 ulp<√a, then r=r′+2 ulp
         Else r=r′+1ulp
8. If the significand of r has r₅₇r₅₈ . . . r₁₁₂=0 and r²=a then the result is exact Else the result is inexact (this can be pre-calculated)

The process detailed above represents an iterative calculation based on the Newton Raphson method, which has been adapted for use with embodiments of the floating point operations described herein. In one embodiment, specific microcode instructions (reduced-latency instructions) are provided to execute one or more operations of the process. In an embodiment, these reduced-latency instructions are configured to replace and/or supplement the standard instruction set of an existing 64-bit microprocessor, such as the Intel® Itanium® 2 processor.

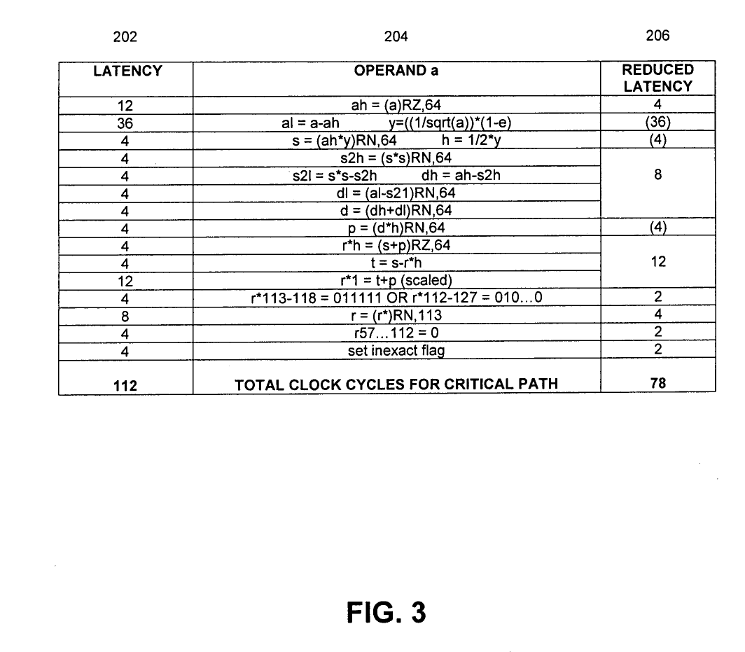

FIG. 3 is a table that lists the principal computations performed in the above process and compares processor clock cycles for the calculation of a floating-point square root value, according to an embodiment. For the embodiment illustrated in FIG. 3, performance metrics for purposes of comparison are specifically provided for a particular 64-bit processor, such as an the Intel® Itanium® 2 processor. Column 204 of FIG. 3 illustrates the computation on operand a during the execution of the process above. Calculations that can be performed in parallel are shown on the same line. The operations illustrated in FIG. 3 represent the main computation that appears in the critical path of the processor in approximately 97% of all operations involving the calculation of the floating-point square root of a quad precision number.

Column 202 indicates the known latency in clock cycles for the Itanium® processor as an example. Column 206 illustrates an estimation of the reduced latency that can be obtained with one or more reduced-latency instructions to execute specific operations 1-8 shown above, according to embodiments of the floating point operations. For those operations for which reduced-latency instructions are not available, the latency values are unchanged and shown in parentheses. As shown in FIG. 3, the potential estimated latency reduction is from 112 clock cycles to 78 clock cycles, or a reduction by a factor of 1.44 (112/78). The computation on the critical path as shown, assumes that the rounding to nearest mode is in effect, which is true in almost all cases. That is, the embodiment of FIG. 3 assumes that the calculation is not a special case. Special cases include, for example, the situation where r*₁₁₂r*₁₁₃ . . . r*₁₂₇=0100 . . . 0, which occurs once in 65536 cases. In such cases the computation branches off on a somewhat longer path than that shown.

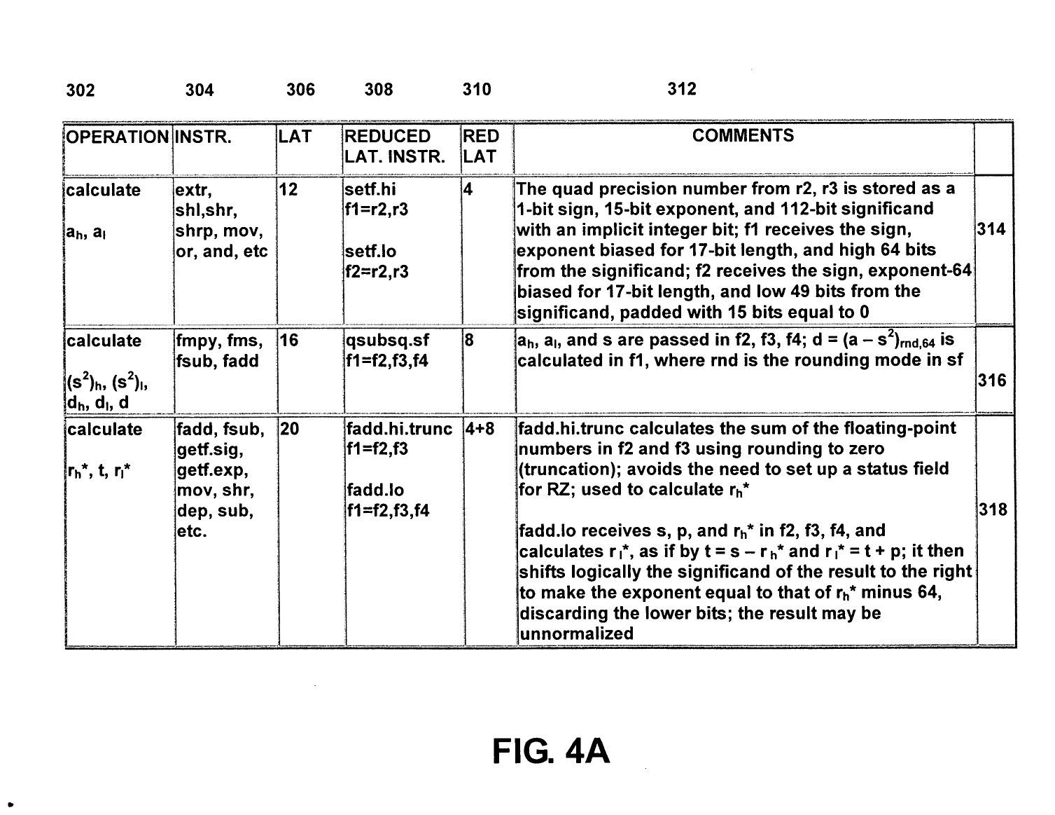

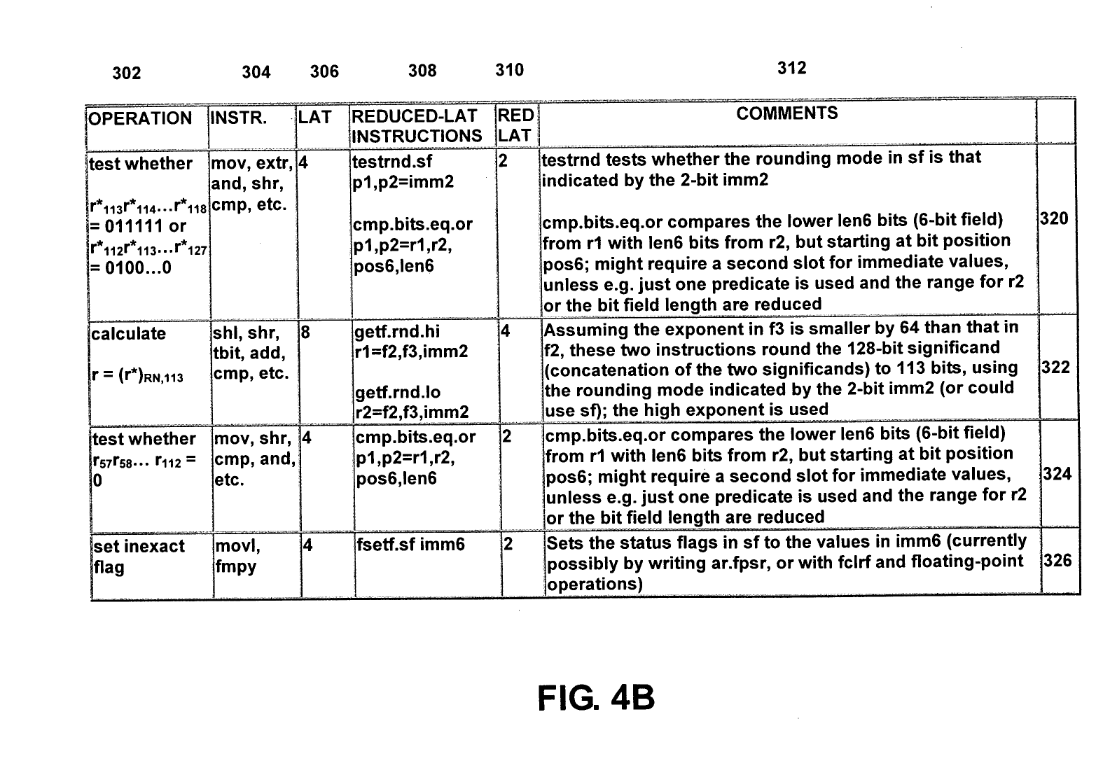

FIGS. 4A-4B are tables that list reduced-latency instructions for performing some of the operations involved in calculating a floating-point square root value, according to one embodiment. The operations listed in column 302 in both figures correspond to some of the specific operations 1-8 above. For the embodiment illustrated in FIG. 4A, the correlation is as follows: the operation in row 314 (calculate aₕ, a₁) corresponds to operation 1; the operation in row 316 corresponds to operation 4; and the operation in row 318 corresponds to operation 6. For the embodiment illustrated in FIG. 4B, the operation in rows 320 and 322 correspond to operation 7; and the operation in rows 324 and 326 correspond to operation 8. By optimizing some of the microprocessor instructions associated with these specific operations within the process, the execution time for the entire square root calculation can be significantly reduced.

As illustrated in FIGS. 4A and 4B, certain specific and current instructions of the Intel® Itanium® 2 are shown in column 304. These instructions are used by the processor to perform the corresponding operations listed in column 302. The latency associated with those instructions (measured as the number of clock cycles to perform the operation), is shown in column 306 of both figures.

Column 308 lists a set of reduced-latency instructions for executing the corresponding operations, according to one embodiment. The notation provided for the reduced-latency instructions in FIGS. 4A and 4B corresponds to established notation for the Intel® Itanium® family of microprocessors, but embodiments are not so limited. Thus, r2 and r3 refers to 64-bit general purpose registers, and f1, f2, f3, and f4 refer to floating-point registers, which are 82-bits each, in the Itanium® processor.

Column 310 for both figures lists the estimated reduced latency associated with the reduced-latency instructions. As can be seen in FIGS. 4A and 4B, reduction of latency is realized for each of the operations as evidenced by the reduced number of clock cycles to perform each operation. For example, operation 1, as shown in row 314, uses only 4 clock cycles with the reduced-latency instruction, as compared with 12 clock cycles using the known instructions of column 304. The other operations exhibit similar latency reductions. For the example of FIGS. 4A and 4B, the reduced-latency instructions reduce the overall latency by approximately 44%.

The reduced-latency instructions outlined in FIGS. 4A and 4B feature the storage and operation of the quad precision (128-bit) operand in the floating-point registers of the processors. In general, 64-bit microprocessors are not configured to natively store quad precision numbers. For the embodiment illustrated in FIGS. 4A and 4B, a first set of reduced-latency or supplemental microprocessor instructions store the quad precision operand in two floating-point registers, and a second set of microprocessor instructions operate on the two floating-point registers to perform arithmetic and logic operations. By utilizing this storage and logic mechanism, the reduced-latency instructions use fewer clock cycles to perform the arithmetic and logic operations as compared to a default native set of microprocessor instructions for floating-point square root calculations.

As shown in row 314 of FIG. 4A, the reduced-latency setf.hi and setf.lo instructions function by storing the quad precision number from registers r2 and r3 as a 1-bit sign, 15-bit exponent, and 112-bit significand plus an implicit integer bit. The f1 register receives the sign, exponent biased for 17-bit length, and high 64 bits from the significand. The f2 register receives the sign, exponent-64 biased for 17-bit length, and low 49 bits from the significand, padded with 15 bits equal to zero.

As shown in row 316 of FIG. 4A, the reduced-latency qsubsq.sf instruction passes the values of aₕ, a₁, and s in registers f2, f3, and f4. The value of d=(a−s²)_{rnd,64} is calculated in register f1, when rnd is the rounding mode in sf, where “sf” refers to one of four status fields within the floating-point status register.

As shown in row 318 of FIG. 4A, the reduced-latency fadd.hi.trunc instruction calculates the sum of the floating-point numbers in registers f2 and f3 using rounding to zero (truncation). This avoids the need to set up a status field for RZ. This value is used to calculate rₕ*. The reduced-latency fadd.lo instruction receives s, p, and rₕ* in registers f2, f3, f4, and calculates the value of r₁*, through the equations: t=s−rₕ* and r₁*=t+p. It then logically shifts the significand of the result to the right to make the exponent equal to that of rₕ* minus 64, discarding the lower bits. The result of this operation may be unnormalized.

As shown in rows 320 and 324 of FIG. 4B, the reduced-latency testrnd.sf instruction tests whether the rounding mode in sf is that indicated by the 2-bit imm2 register. The reduced-latency cmp.bits.eq.or instruction compares the lower len6 bits (6-bit field) from register r1 with len6 bits from register r2, but starting at bit position pos6. This may use a second slot for immediate values, unless for example, just one predicate is used and the range for r2 or the bit field length is reduced.

As shown in row 322 of FIG. 4B, the reduced-latency getf.rnd.hi and getfrnd.lo instructions round the 128-bit significand (concatenation of the two significands) to 113 bits, using the rounding mode indicated by the 2-bit imm2 (or sf) register. For these instructions, the high exponent is used, and it is assumed that the exponent in register f3 is smaller by 64 than that in register f2.

As shown in row 326 of FIG. 4B, the reduced-latency fsetf.sf instruction sets the status flags in sf to the values in imm6. In one embodiment, for the Itanium® processor, this can be done by writing ar.fpsr, where “ar” is the application register, or with fclrf and floating-point operations.

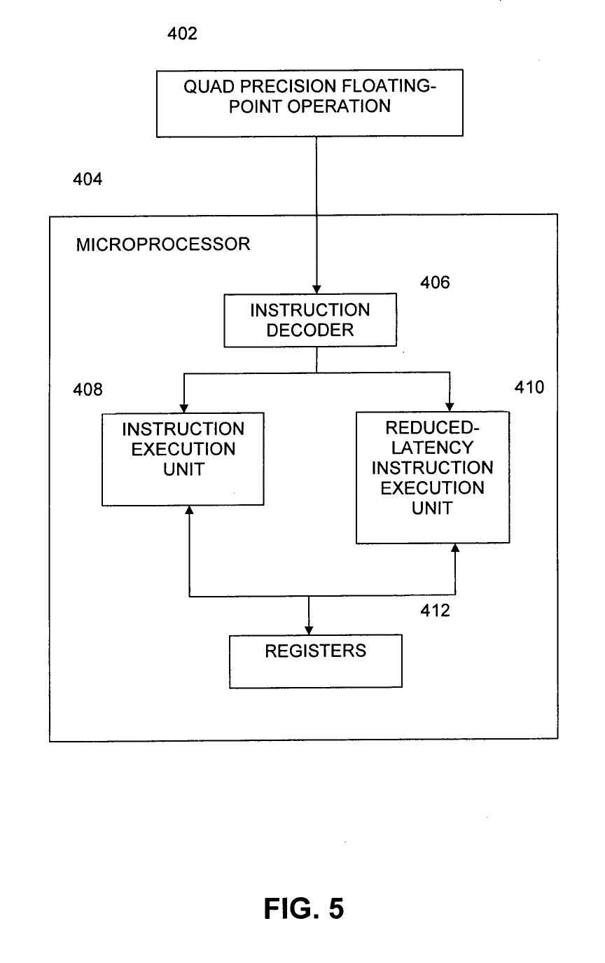

FIG. 5 is a block diagram of a microprocessor that includes reduced-latency instructions for executing a quad precision floating-point operation, according to one embodiment. The microprocessor 404 includes or is coupled to an instruction decoder 406 that receives program code from a program or routine that is to be executed by the processor. The program code includes operations that are executed using one or more instructions of the microprocessor. The program may be a quad precision floating-point operation 402 that uses quad precision floating-point square root operations or instructions, such as those illustrated in FIGS. 4A and 4B. For the embodiment of FIG. 5, the program operations are executed by the execution unit 408 for a known instruction set of the microprocessor 404, as well as the execution unit 410 for the reduced-latency instructions of the microprocessor 404. The known and reduced-latency instructions act on one or more registers 412 through one or more logic and arithmetic functions. For the case in which the program to be executed is a quad precision floating-point square root operation, such as that in FIGS. 4A and 4B, the registers 412 include at least four floating-point (e.g., 82-bit) registers, as well as other registers, but the embodiment is not so limited.

The reduced-latency instructions outlined in FIGS. 4A and 4B are configured to run with the register set and architecture of the Intel® Itanium® family of processors, but embodiments are not so limited. The reduced-latency instructions and reduced-latency instruction execution unit illustrated and described in relation to the embodiments of FIGS. 3, 4A, and 4B can represent instructions that replace or supplement the instructions of the microprocessor, or modified instructions, or any combination of instructions that more efficiently perform a quad precision floating-point operation compared to a default set of instructions for that operation.

The processes and instructions described herein can be adapted for use with other processors and processor architectures using techniques known to those of ordinary skill in the art. The term “processor” as generally used herein refers to any logic processing unit, such as one or more central processing units (“CPU”), digital signal processors (“DSP”), application-specific integrated circuits (“ASIC”), and so on. The processor can be monolithically integrated onto a single chip, distributed among a number of chips or components of a host system, and/or provided by some combination of algorithms. The reduced-latency instructions described above feature enhanced instruction-level parallelism, which make them suited for processors with pipelined functional units, multiple functional units, or multiple cores.

The reduced-latency instruction set illustrated in FIGS. 4A and 4B can be implemented in any combination of microcode, microoperations (microops), software algorithm(s), subroutines, firmware, and hardware running on one or more processors. In software form, the reduced-latency instructions and methods according to embodiments of the floating point operations can be stored on any suitable computer-readable medium, such as microcode stored in a semiconductor chip, on a computer-readable disk, or downloaded from a server and stored locally at the host device, for example.

Aspects of the floating-point operations described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the floating-point operations include: microcontrollers with memory (such as EEPROM), embedded microprocessors, firmware, software, etc. Furthermore, aspects of the floating-point operations may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of floating-point operations is not intended to be exhaustive or to limit the floating-point operations to the precise form or instructions disclosed. While specific embodiments of, and examples for, the floating-point operations are described herein for illustrative purposes, various equivalent modifications are possible within the scope of floating-point operations, as those skilled in the relevant art will recognize. Moreover, the teachings of the floating-point operations provided herein can be applied to other floating-point operations, such as quad precision division.

The elements and acts of the various embodiments described above can be combined to provide further embodiments. These and other changes can be made to the floating-point operations in light of the above detailed description.

In general, in the following claims, the terms used should not be construed to limit the floating-point operations to the specific embodiments disclosed in the specification and the claims, but should be construed to include all operations or processes that operate under the claims. Accordingly, the floating-point operations are not limited by the disclosure, but instead the scope of the recited embodiments is to be determined entirely by the claims.

While certain aspects of the floating-point operations are presented below in certain claim forms, the inventor contemplates the various aspects of the floating-point operations in any number of claim forms. For example, while only one aspect of the square root instruction set is recited as embodied in machine-readable medium, other aspects may likewise be embodied in machine-readable medium. Accordingly, the inventor reserves the right to add additional claims after filing the application to pursue such additional claim forms for other aspects of the floating-point operations.

1. A processing system comprising:
an instruction decoder that receives instructions for a quad precision floating-point operation; and
an instruction execution unit coupled to the instruction decoder, the instruction execution unit to execute a plurality of instructions that perform floating-point operations on a quad precision operand, to
calculate an approximation of a reciprocal of a square root of the quad precision operand using an iteration, wherein the approximation is an underestimate;
round the approximation to one of two nearest quad precision floating-point numbers; and
output a floating-point square root of the quad precision operand based on the rounded approximation.

2. The system of claim 1, further comprising a plurality of registers coupled to the instruction execution unit, wherein a first set of the plurality of instructions stores the quad precision operand in two floating-point registers of the plurality of registers.

3. The system of claim 2, wherein a second set of the plurality of instructions operates on the floating-point registers to perform arithmetic and logic operations on the quad precision operand.

4. A method for calculating a floating-point square root of a quad 2 precision operand in a microprocessor, comprising:
calculating an approximation of a reciprocal of a square root of the quad precision operand;
calculating and rounding a result of the approximation to one of two nearest quad precision floating-point numbers;
adding one unit in a last place to a rounded result if an exceptional case exists for a rounding mode; and
determining whether the result is exact or inexact.

5. The method of claim 4, wherein:
a first set of microprocessor instructions store the quad precision operand in two floating-point registers; and
a second set of microprocessor instructions operate on the floating-point registers to perform arithmetic and logic operations on the quad precision operand.

6. The method of claim 5, wherein the first and second set of microprocessor instructions comprise instructions that utilize relatively fewer clock cycles to perform the arithmetic and logic operations as compared to a set of instructions configured to perform floating-point square root calculations.

7. The method of claim 6, wherein the microprocessor is a 64-bit microprocessor, and the two floating-point registers are each 82-bit registers.

8. The method of claim 7, wherein calculating the approximation of the reciprocal of the square root of the operand comprises calculating a 64-bit underestimate.

9. The method of claim 7, further comprising:
storing, by a first instruction of the first set of microprocessor instructions, a higher order part of the quad precision operand in a first floating-point register; and
storing, by a second instruction of the first set of microprocessor instructions, a lower order part of the quad precision operand in a second floating-point register.

10. The method of claim 9 further comprising storing the quad precision operand as a 1-bit sign, a 15-bit exponent, and a 112-bit significand with an implicit integer bit.

11. The method of claim 5, further comprising a first instruction summing respective parts of floating-point numbers stored in the two floating-point registers.

12. The method of claim 5 further comprising rounding, by a second instruction of the second set of microprocessor instructions, the significand using a rounding mode indicated by a status field of a register in the microprocessor.

13. The method of claim 12, wherein the rounding mode corresponds to a rounding mode specified by the proposed revised IEEE 754 standard.

14. A machine-readable medium including instructions which, when executed in a processing system, calculate a floating-point square root of a quad precision operand in a microprocessor by:
calculating an approximation of a reciprocal of the square root of the operand;
calculating and rounding a result of the approximation to one of two nearest quad precision floating-point numbers;
adding one unit in a last place to a rounded result if an exceptional case exists for a rounding mode; and
determining whether the result is exact or inexact, wherein, a first set of microprocessor instructions stores the quad precision operand in two floating-point registers, and a second set of microprocessor instructions operates on the floating-point registers to perform arithmetic and logic operations on the operand.

15. The medium of claim 14, wherein calculating the approximation of the reciprocal of the square root of the operand comprises calculating a 64-bit underestimate.

16. The medium of claim 14, further comprising:
a first instruction of the first set of microprocessor instructions to store a higher order part of the quad precision operand in a first floating-point register; and
a second instruction of the first set of microprocessor instructions to store a lower order part of the quad precision operand in a second floating-point register.

17. The medium of claim 16, wherein the quad precision operand is stored as a 1-bit sign, a 15-bit exponent, and a 112-bit significand with an implicit integer bit.

18. The medium of claim 17, further comprising a first instruction of the second set of microprocessor instructions to calculate the sum of floating-point numbers stored in the two floating-point registers.

19. The medium of claim 18, further comprising a second instruction of the second set of microprocessor instructions to round the significand using a rounding mode indicated by a status field of a register in the processing system.

20. An apparatus comprising:
an instruction decoder to receive instructions for a quad precision floating-point square root operation to be executed by the processing system;
a plurality of registers;
a primary instruction set execution unit coupled to the instruction decoder and the plurality of registers; and
a secondary instruction execution unit coupled to the instruction decoder and the plurality of registers, the secondary instruction execution unit executing a first set of microprocessor instructions and a second set of microprocessor instructions to
calculate an approximation of a reciprocal of a square root of the operand;
calculate and round a result of the approximation to one of two nearest quad precision floating-point numbers;
add one unit in the last place to the rounded result if an exceptional case exists for a rounding mode; and
determine whether the result is exact or inexact.

21. The apparatus of claim 20, wherein the first set of microprocessor instructions stores the quad precision operand in two floating-point registers of the plurality of registers, and the second set of microprocessor instructions operates on the floating-point registers to perform arithmetic and logic operations on the operand.

22. The apparatus of claim 21, wherein a first instruction of the first set of microprocessor instructions stores a higher order part of the quad precision operand in a first floating-point register, and a second instruction of the first set of microprocessor instructions stores a lower order part of the quad precision operand in a second floating-point register.

23. The apparatus of claim 22 wherein the quad precision operand is stored as a 1-bit sign, a 15-bit exponent, and a 112-bit significand with an implicit integer bit.

24. The apparatus of claim 23, wherein a first instruction of the second set of microprocessor instructions calculates the sum of floating-point numbers stored in the two floating-point registers, and a second instruction of the second set of microprocessor instructions rounds the significand using a rounding mode indicated by status field of a register of the plurality of registers.
